(19) United States
(12) Patent Application Publication
(10) Pub. No.: US 2023/0350654 A1
(43) Pub. Date: Nov. 2, 2023

(54) SYSTEMS AND METHODS FOR CONVOLUTIONAL NEURAL NETWORK OBJECT DETECTION AND CODE REPAIR

(71) Applicant: BANK OF AMERICA CORPORATION, Charlotte, NC (US)

(72) Inventors: Vijay Kumar Yarabolu, Hyderabad (IN); Jorge Kara, Kirkland, WA (US)

(73) Assignee: BANK OF AMERICA CORPORATION, Charlotte, NC (US)

(21) Appl. No.: 17/732,082

(22) Filed: Apr. 28, 2022

(51) Int. Cl. G06K 9/62; G06F 8/41; G06F 8/10; G06N 3/04; G06F 8/70

(52) U.S. Cl. CPC G06F 8/4434; G06F 8/10; G06F 8/70; G06K 9/6256; G06K 9/6277; G06N 3/04

(57) ABSTRACT

Embodiments of the present invention comprise systems, methods, and computer program products providing an artificial intelligence (AI) powered solution to self-heal script failures and to maintain UI code as up-to-date according to application changes. The invention introduces the use of convolutional neural networks (CNNs) in test automation for visual identification of UI objects and classification of corresponding code language requirements for the UI objects. The invention may include building dynamic UI objects in the event of detected failures within a test environment.

### FIELD OF THE INVENTION

The present invention generally relates to the field of automated and flexible information extraction for use in repairing code where necessary. In particular, the novel present invention provides a unique platform for analyzing, classifying, extracting, and processing information from user interface imagery using deep learning image detection models. Embodiments of the inventions are configured to provide an end to end automated solution for code repair.

### BACKGROUND

Tools for data extraction from images which provide an end to end automated solution for extraction and classification of data in consistent useable format are valuable for processing and inferring context regarding graphical information. In many current processes, techniques and systems, a user is required to manually analyze user interface attributes and determine where underlying code failures may exist, and further determine the solution to create a streamlined user interface experience. As such, this multi-step process can be time consuming and complex. Current solutions may also be prone to human error and result in data that is not uniform. The output data produced by conventional neural network solutions have a potential for producing an automated, consistent, and streamlined solution for analysis and issue resolution with regard to user interface elements and the underlying code for such elements.

In terms of conventional solutions for semi-automated code repair, automation engineers may expend unnecessary effort on the job to ensure that an automation suite is in sync with application changes and code requirements. Despite best efforts, automation scripts frequently fail due to rapid application changes and evolvements over time. Sometimes the application code is different in different test environments, for example. User interface (UI) elements coded in a quality assurance environment could be different in pre-production environment, for instance. Due to these challenges, testers chose to perform selective test execution to complete the certification on time. This leaves a chance to miss a defect in a final product. Hence there should be a stronger solution in place to keep the automation suite up to date with minimal effort and time.

The previous discussion of the background to the invention is provided for illustrative purposes only and is not an acknowledgement or admission that any of the material referred to is or was part of the common general knowledge as at the priority date of the application.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention comprise systems, methods, and computer program products that address these and/or other needs by providing an artificial intelligence (AI) powered solution to self-heal script failures and to maintain UI code as up-to-date according to application changes. The invention introduces the use of convolutional neural networks (CNNs) in test automation for visual identification of UI objects and classification of corresponding code language requirements for the UI objects. The invention may include building dynamic UI objects in the event of detected failures within a test environment .

The system may include an initial automation suite which is developed such that a trial run can be completed to verify the stability and accuracy of system-generated scripts. The system may be programmed to capture metadata from UI objects, such as image and visual recognition characteristics of each UI object during the trial runs. The system may build an image object repository, dynamically over time, with all gathered details and metadata regarding UI objects. This data may be used to train a convolutional neural network (CNN) on an image object repertory. During a certification-run, the CNN model may verify if a given object is visually available, and may identify if a failure is visually present in the UI. Upon determining the given object’s availability, the system may prompt the CNN generate corresponding unique properties for the given object. As such, the system may build the dynamic object using unique properties and associated scripts which code for those unique properties, essentially completely automating a solution to identify and fix UI issues in cases where a user would typically be required to visually identify the error in the first place.

Typically the system comprises: at least one memory device with computer-readable program code stored thereon; at least one communication device; at least one processing device operatively coupled to the at least one memory device and the at least one communication device, wherein executing the computer-readable code is configured to cause the at least one processing device to: receive an original image for analysis from a user device, wherein the original image comprises an image displayed on a graphical user interface of the user device; encode the original image using multiple convolutional neural network layers; store pooling indices for feature variance layers of the encoded image; determine a classification on the feature variance layers of the encoded image; and generate an output, wherein the output comprises a probabilistic distribution of one or more user interface objects within the original image.

In some embodiments, the system is further configured to: apply a softmax activation function to determine the probabilistic distribution of one or more user interface objects within the original image.

In some embodiments, the feature variance layers of the encoded image are combined into a flattened layer

one or more failures within a current deployment of the user interface; and prior to determining the classification.

In some embodiments, the one or more user interface objects comprise one or more of a text box, link, button, or check box within the original image.

In some embodiments, the system is further configured to: reference a user interface object repository to determine one or more scripts corresponding the one or more user interface objects within the original image.

In some embodiments, the user interface object repository further comprises a table of object properties, object descriptions, and object examples.

In some embodiments, the system is further configured to identify one or more failures within a current deployment of the user interface; and automate a solution to the one or more failures using data from the object repository.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts an intelligent code repair system environment 100, in accordance with one embodiment of the present invention;

FIG. 2 depicts a process flow 200 for training CNN models for automated code repair, in accordance with one embodiment of the present invention.

FIG. 3 depicts an additional process flow 300 for a self-healing process utilizing a trained CNN model, in accordance with one embodiment of the present invention;

FIG. 4 depicts a process flow diagram 400 of CNN model usage for user interface processing, in accordance with one embodiment of the present invention;

FIG. 5 depicts a sample user interface 500, in accordance with one embodiment of the present invention; and

FIG. 6 depicts sample object properties, including descriptions, and examples, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

In some embodiments, an “entity” or “enterprise” as used herein may be any institution employing information technology resources and particularly technology infrastructure configured for large scale processing of electronic files, electronic technology event data and records, and performing/processing associated technology activities. In some instances, the entity’s technology systems comprise multiple technology applications across multiple distributed technology platforms for large scale processing of technology activity files and electronic records. As such, the entity may be any institution, group, association, financial institution, establishment, company, union, authority or the like, employing information technology resources.

As described herein, a “user” is an individual associated with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer. In other embodiments, a user may be a system performing one or more tasks described herein.

In the instances where the entity is a financial institution, a user may be an individual or entity with one or more relationships affiliations or accounts with the entity (for example, a financial institution). In some embodiments, the user may be an entity or financial institution employee (e.g., an underwriter, a project manager, an IT specialist, a manager, an administrator, an internal operations analyst, bank teller or the like) capable of operating the system described herein. In some embodiments, a user may be any individual or entity who has a relationship with a customer of the entity or financial institution. For purposes of this invention, the term “user” and “customer” may be used interchangeably. A “technology resource” or “account” may be the relationship that the user has with the entity. Examples of technology resources include a deposit account, such as a transactional account (e.g. a banking account), a savings account, an investment account, a money market account, a time deposit, a demand deposit, a pre-paid account, a credit account, or the like. The technology resource is typically associated with and/or maintained by an entity.

As used herein, a “user interface” or “UI” may be an interface for user-machine interaction. In some embodiments the user interface comprises a graphical user interface. Typically, a graphical user interface (GUI) is a type of interface that allows users to interact with electronic devices such as graphical icons and visual indicators such as secondary notation, as opposed to using only text via the command line. That said, the graphical user interfaces are typically configured for audio, visual and/or textual communication. In some embodiments, the graphical user interface may include both graphical elements and text elements. The graphical user interface is configured to be presented on one or more display devices associated with user devices, entity systems, processing systems and the like. In some embodiments the user interface comprises one or more of an adaptive user interface, a graphical user interface, a kinetic user interface, a tangible user interface, and/or the like, in part or in its entirety.

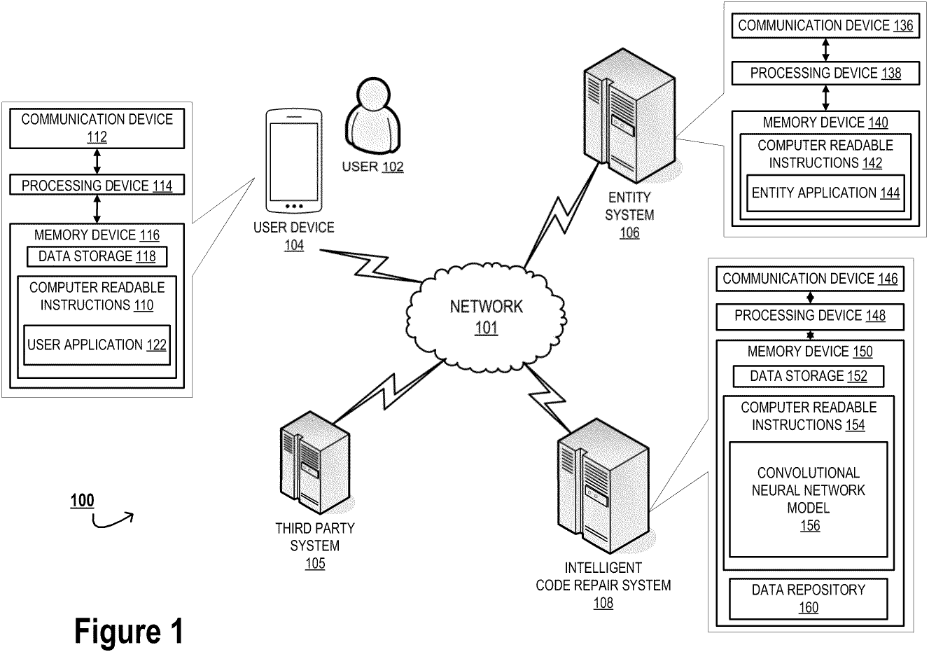

FIG. 1 depicts intelligent display protection system environment 100, in accordance with one embodiment of the present invention. As illustrated in FIG. 1, an intelligent code repair system 108 is operatively coupled, via a network 101 to a user device 104, to an entity system 106, and to a third party system 105. In this way, the intelligent code repair system 108 can send information to and receive information from the user device 104, the entity system 106, and the third party system 105. FIG. 1 illustrates only one example of an embodiment of the system environment 100, and it will be appreciated that in other embodiments one or more of the systems, devices, or servers may be combined into a single system, device, or server, or be made up of multiple systems, devices, or servers. In this way, the intelligent code repair system 108, is configured for receiving user device data and user data, discerning or inferring situational needs of the user, and implementing an intelligent dynamic screen protection process via the convolutional encoding and decoding of image data using one or more steganographic functions for the selective obfuscation of graphical image data.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 may be one or more individuals or entities that may either provide images for analysis, recognition and extraction, query the intelligent code repair system 108 for identified attributes, set parameters and metrics for data analysis, and/or receive/utilize centralized database information created and disseminated by the intelligent code repair system 108. As such, in some embodiments, the user 102 may be associated with the entity and/or a financial institution. In other embodiments, the user 102 may be associated with another system or entity, such as third party system 105, which may be granted access to the intelligent code repair system 108 or entity system 106 in some embodiments.

FIG. 1 also illustrates a user device 104. The user device 104 may be, for example, a desktop personal computer, a mobile system, such as a cellular phone, smart phone, personal data assistant (PDA), laptop, or the like. The user device 104 generally comprises a communication device 112, a processing device 114, and a memory device 116. The user device 104 is typically a computing system that is configured to enable user and device authentication for access to various data from the system 108, or transmission of various data to the system 108. The processing device 114 is operatively coupled to the communication device 112 and the memory device 116. The processing device 114 uses the communication device 112 to communicate with the network 101 and other devices on the network 101, such as, but not limited to, the entity system 106, the intelligent code repair system 108 and the third party system 105. As such, the communication device 112 generally comprises a modem, server, or other device for communicating with other devices on the network 101.

The user device 104 comprises computer-readable instructions 110 and data storage 118 stored in the memory device 116, which in one embodiment includes the computer-readable instructions 110 of a user application 122. In some embodiments, the intelligent code repair system 108 and/or the entity system 106 are configured to cause the processing device 114 to execute the computer readable instructions 110, thereby causing the user device 104 to perform one or more functions described herein, for example, via the user application 122 and the associated user interface.

As further illustrated in FIG. 1, the intelligent code repair system 108 generally comprises a communication device 146, a processing device 148, and a memory device 150. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device, such as the processing device 148, typically includes functionality to operate one or more software programs, based on computer-readable instructions thereof, which may be stored in a memory device, for example, executing computer readable instructions 154 or computer-readable program code 154 stored in memory device 150 to perform one or more functions associated with the intelligent code repair system 108.

The processing device 148 is operatively coupled to the communication device 146 and the memory device 150. The processing device 148 uses the communication device 146 to communicate with the network 101 and other devices on the network 101, such as, but not limited to the entity system 106, the third party system 105, and the user device 104. As such, the communication device 146 generally comprises a modem, server, or other device for communicating with other devices on the network 101.

As further illustrated in FIG. 1, the intelligent code repair system 108 comprises the computer-readable instructions 154 stored in the memory device 150, which in one embodiment includes the computer-readable instructions for the implementation of a convolutional neural network model (“CNN model”) 156. In some embodiments, the computer readable instructions 154 comprise executable instructions associated with the CNN model 156, wherein these instructions, when executed, are typically configured to cause the applications or modules to perform/execute one or more steps described herein. In some embodiments, the memory device 150 includes data storage 152 for storing data related to the system environment, but not limited to data created and/or used by the CNN model 156 and its components/modules. The CNN model 156 is further configured to perform or cause other systems and devices to perform the various steps in processing software code and user interface elements, graphical elements, or the like, as will be described in detail later on.

As such, the processing device 148 is configured to perform some or all of the data processing and event capture, transformation and analysis steps described throughout this disclosure, for example, by executing the computer readable instructions 154. In this regard, the processing device 148 may perform one or more steps singularly and/or transmit control instructions that are configured to the CNN model 156, entity system 106, user device 104, and third party system 105 and/or other systems and applications, to perform one or more steps described throughout this disclosure. Although various data processing steps may be described as being performed by the CNN model 156 and/or its components/applications and the like in some instances herein, it is understood that the processing device 148 is configured to establish operative communication channels with and/or between these modules and applications, and transmit control instructions to them, via the established channels, to cause these module and applications to perform these steps.

Embodiments of the intelligent code repair system 108 may include multiple systems, servers, computers or the like maintained by one or many entities. FIG. 1 merely illustrates one of those systems 108 that, typically, interacts with many other similar systems to form the information network. In one embodiment of the invention, the intelligent code repair system 108 is operated by the entity associated with the entity system 106, while in another embodiment it is operated by a second entity that is a different or separate entity from the entity system 106. In some embodiments, the entity system 106 may be part of the intelligent code repair system 108. Similarly, in some embodiments, the intelligent code repair system 108 is part of the entity system 106. In other embodiments, the entity system 106 is distinct from the intelligent code repair system 108.

In one embodiment of the intelligent code repair system 108, the memory device 150 stores, but is not limited to, the CNN model 156. In one embodiment of the invention, the CNN model 156 may associated with computer-executable program code that instructs the processing device 148 to operate the communication device 146 to perform certain communication functions involving the third party system 105, the user device 104 and/or the entity system 106, as described herein. In one embodiment, the computer-executable program code of an application associated with the CNN model 156 may also instruct the processing device 148 to perform certain logic, data processing, and data storing functions of the application.

The processing device 148 is configured to use the communication device 146 to receive data, such as images, or metadata associated with images, transmit and/or cause display of extracted data and the like. In the embodiment illustrated in FIG. 1 and described throughout much of this specification, the CNN model 156 may perform one or more of the functions described herein, by the processing device 148 executing computer readable instructions 154 and/or executing computer readable instructions associated with one or more application(s)/devices/components of the CNN model 156.

As illustrated in FIG. 1, the entity system 106 is connected to the intelligent code repair system 108 and may be associated with a financial institution network. In this way, while only one entity system 106 is illustrated in FIG. 1, it is understood that multiple network systems may make up the system environment 100 and be connected to the network 101. The entity system 106 generally comprises a communication device 136, a processing device 138, and a memory device 140. The entity system 106 comprises computer-readable instructions 142 stored in the memory device 140, which in one embodiment includes the computer-readable instructions 142 of an institution application 144. The entity system 106 may communicate with the intelligent code repair system 108. The intelligent code repair system 108 may communicate with the entity system 106 via a secure connection generated for secure encrypted communications between the two systems for communicating data for processing across various applications.

As further illustrated in FIG. 1, in some embodiments, the intelligent display protection system environment 100 further comprises a third party system 105, in operative communication with the intelligent code repair system 108, the entity system 106, and/or the user device 104. Typically, the third party system 105 comprises a communication device, a processing device and memory device with computer readable instructions. In some instances, the third party system 105 comprises a first database/repository comprising software code or program component objects, and/or a second database/repository comprising functional source code associated with software or program component objects and attributes. These applications/databases may be operated by the processor executing the computer readable instructions associated with the third party system 105, as described previously. Although a single external third party system 105 is illustrated, it should be understood that, the third party system 105 may represent multiple technology servers operating in sequentially or in tandem to perform one or more data processing operations.

It is understood that the servers, systems, and devices described herein illustrate one embodiment of the invention. It is further understood that one or more of the servers, systems, and devices can be combined in other embodiments and still function in the same or similar way as the embodiments described herein.

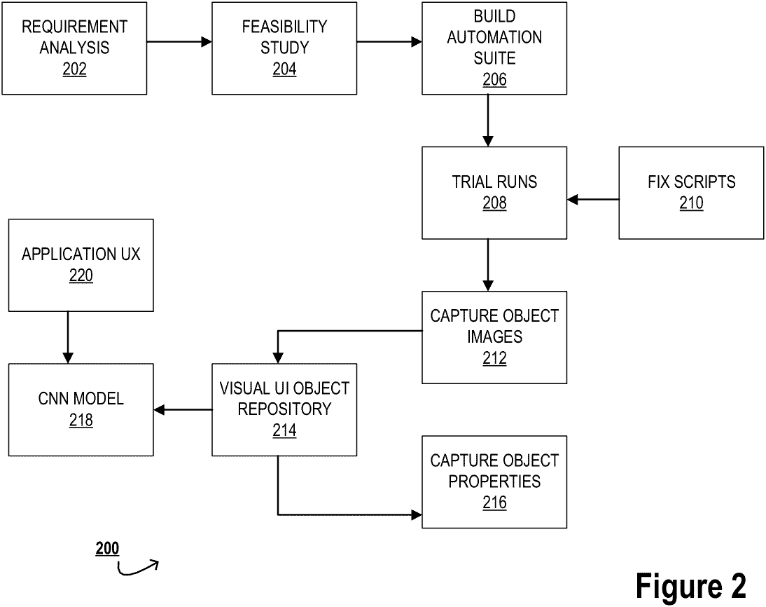

FIG. 2 depicts a process flow 200 for training CNN models for automated code repair, in accordance with one embodiment of the present invention. A convolutional neural network (“CNN”) is a class of deep, feed-forward artificial neural networks, most commonly applied to analyzing visual imagery. Compared to other image classification algorithms, CNNs use relatively little pre-processing, and in some embodiments the CNN uses a recurring parametric network optimization to learn filters that traditionally are hand-engineered. This results in a reduction of human effort which offers a major advantage over conventional applications. In some embodiments, the present invention utilizes a mask region CNN in order to segment images and analyze pixel content in order to identify and extract image attributes based on their particular contours, and identify these attributes using mask layers. As shown in block 202, the process begins by conducting a requirement analysis, accompanied by a feasibility study, as shown in block 204. In these steps, testing is performed on various user interface (UI) elements in order to determine if any underlying code segments for particular UI elements can be automated. If so, an automation suite may be built, as shown in block 206. The process continues by conducting one or more trial runs 208 in order to fix scripts 210 within the underlying code of an application’s user experience (UX).

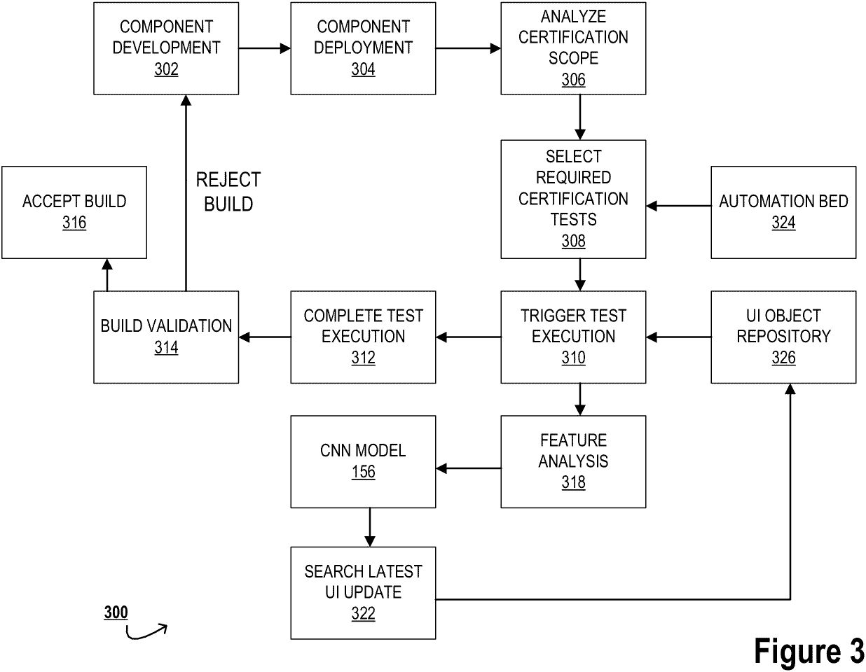

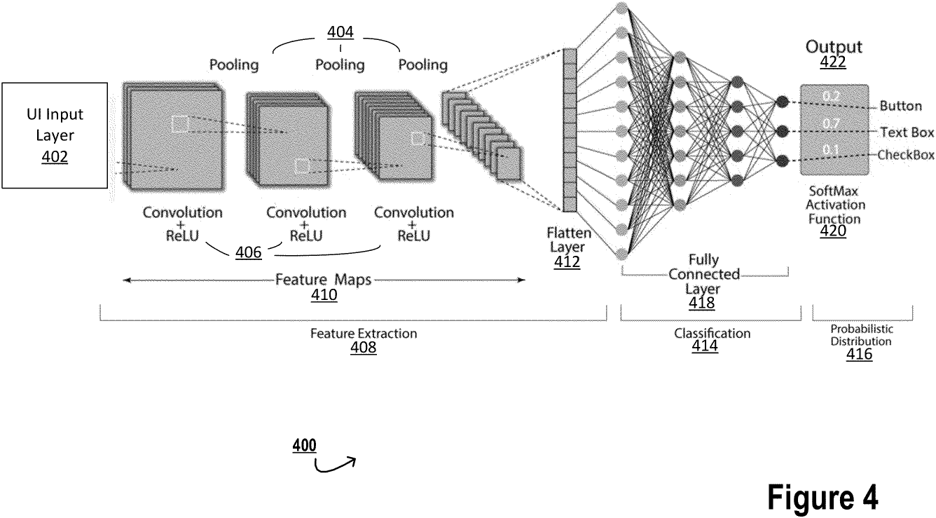

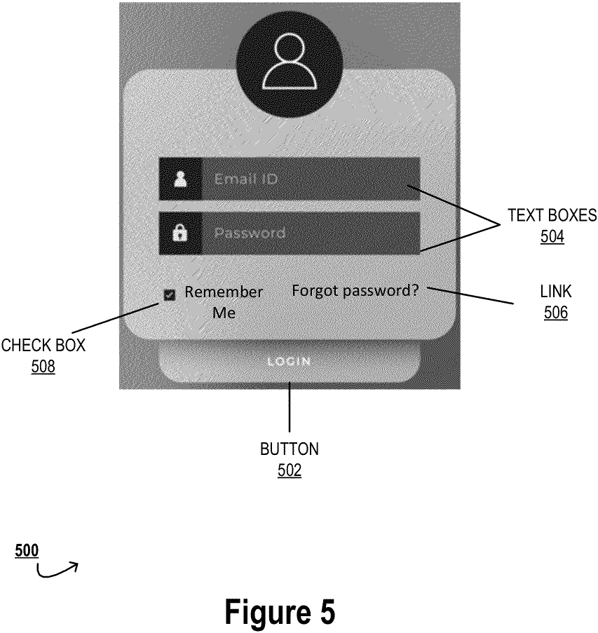

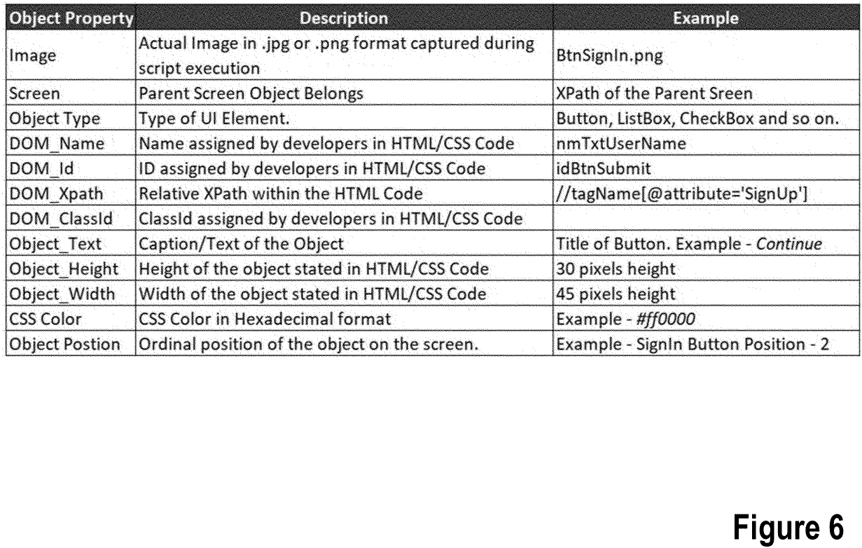

During this process, object images of the UI are captured, as shown in block 212, and used to build a visual UI object repository 214. In the course of building the visual UI object repository, certain object properties are also captured, both in terms of image contour and analysis data, as well as descriptive metadata, as exemplified in FIG. 6. This data is provided to a convolutional neural network (CNN) model 218. The CNN model 218 also receives data for processing from one or more application user experiences (UX), as later described in FIG. 3, FIG. 4, and FIG. 5.

FIG. 3 depicts an additional process flow 300 for a self-healing process utilizing a trained CNN model, in accordance with one embodiment of the present invention. As shown, the process includes an iterative feedback loop wherein component development 302 occurs to build out various features of the UI. This may involve initially manually or semi-automatically coding for various UI features using one or more coding languages or graphical user interfaces for object or component deployment 304 within the UI. The certification scope is then analyzed, as shown in block 306, to verify the stability and accuracy of underlying scripts for the component deployment 304. The process continues by selecting required certification tests, as shown in block 308, which may involve drawing data from a pre-populated automation bed 324. The process then continues by triggering a test execution, as shown in block 310, wherein a feature analysis 318 is conducted by the CNN model 156. The CNN model 156 is tasked with applying one or more mask layers to an image of the deployed object components within the UI, which allows the CNN model 156 to automatically identify features within the UI. Once the feature analysis 318 has been conducted using the CNN model 156, the system may search a latest UI update, as shown in block 322, by referencing a UI object repository 326 to compare identified features within the UI to known features, and automatically check that the scripts pass select certification tests. The process then proceeds to complete test execution, as shown in block 312. The build of the UI is then either accepted or rejected by a build validation 314 process. If the build is rejected, the process may iteratively return to the component development 302 stage, wherein features and objects within the UI may be altered or re-programmed in order to fix any underlying issues regarding how the UI is presented or interacted with. Via use of the CNN model 156, the process for certification may be automated and streamlined in a manner that significantly reduces the amount of time involved in ensuring that the component deployment is up to date.

FIG. 4 depicts a process flow diagram 400 of CNN model usage for user interface processing, in accordance with one embodiment of the present invention. As previously mentioned, a convolutional neural network (“CNN”) is a class of deep, feed-forward artificial neural networks, most commonly applied to analyzing visual imagery. The CNN model 156 may be trained to contain filters for identifying user interface elements, or graphical elements, or the like. Most any image introduced into the CNN model 156 will contain some non-uniformity with respect to how the features are distributed throughout the overall image. For instance, the user interface graphical elements of a particular login screen (such as those provided via UI input layer 402) may not be distributed in a linear fashion throughout the image, web forms may vary in the arrangement and types of fields shown, or the like, and so the CNN model 156 must contain a non-linear activation function which is applied in each encoding convolution layer in order to account for this non-uniformity. In other words, taking the example of the user interface image, since an increase in number of objects identified is not linearly correlated with movement in strictly the x axis direction or movement in the y axis direction across the image, the model must account for this non-linearity by applying the non-linear activation function. In some embodiments the non-linear activation function used in the convolution layers may be a “tanh,” “sigmoid,” or “ReLU” algorithm, as indicated at items convolution ReLU 406. The filter size, batch normalization function, and non-linear activation function may differ for each layer of convolution ReLU 406.

The system may then identify and extract data series and contours from an image from UI input layer 402, wherein the data series and contours and partially identified based on relative and proportional data determined by an object mask layer. In some embodiments, the recognition of data series from contours may be achieved by use of a combination of regression analysis, text mining, and classification analysis. This data may be organized and stored in data repository 160 such that it can be easily incorporated into a detailed dashboard of image features, such as UI object repository 326. The process may apply an optical character recognition process to transform any identified text data into a searchable format, and generates a segmented image. Segmented information and identified text data is compiled and stored in the data repository 160.

As the filters are applied to the image, each encoder convolution layer contains a pooling 404 step where the dimension of the encoded image is reduced to highlight only critical information. Data regarding how the encoded images are reduced is stored as a pooling index. These pooling 404 indices are carried over into the decoding network and the decoding network applies additional convolution layers which expand the pooling indices to predict the original image. In some embodiments, the CNN model 156 may use a min or max pooling method, while in other embodiments the CNN model 156 may use an average pooling method. Each encoder convolution layer may also contains a batch normalization step which scales the encoded image data to a normalized scale. Applying batch normalization at encoder convolution layers effectively reduces internal covariance shift and aids in reaching convergence of the decoded image as compared to the original image by giving the CNN model 156 more generic decision functions. The filters used in the CNN model 156 are trained over time using a feedback process of encoding and decoding in order to achieve a resultant model which can identify a specific feature set. The data within the matrices of the filters is weighted to identify specific features based on training data.

Next, the CNN model implements a flatten layer 412 which involves converting the data into a 1-dimensional array for inputting it to the next layer. The image is flattened as the output of the convolutional layers to create a single long feature vector. This completes the subprocess of feature extraction 408. The output of feature extraction 408 is then connected to the final classification 414 model, as fully connected layer 418. In other words, the model combines all pixel data in one line and makes connections with a final layer. This allows output 422 to include a probabilistic distribution 416 of likely features within a user interface image (e.g., button, text, checkbox, or the like), via use of a SoftMax activation function 420, which is a Python function that converts a vector of numbers into a vector of probabilities.

FIG. 5 depicts a sample user interface 500, in accordance with one embodiment of the present invention. As shown in FIG. 5, the UI may include various features, including, but not limited to, button(s) 502, text boxes 504, link(s) 506, and check box(es) 508. The sample UI shown in FIG. 5 is for exemplary purposes only, and does not represent a limiting example of all the UI features and components that may be visually identified by the CNN model 156. Moving further, FIG. 6 depicts sample object properties, descriptions, and examples, in accordance with one embodiment of the present invention. As shown, object properties may include identifiers such as “image,” “screen,” “DOM _name,” or the like, which may be identified by the CNN model 156 via referencing the UI object repository. For reference to users of the system, the UI object repository may include additional descriptive metadata, such as the various descriptions shown in FIG. 6. A representative example, such as a file name, file path, color code, or the like, may also be listed in the UI object repository, as indicated on the righthand side of the table in FIG. 6.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for automated user interface development, the system comprising:
at least one memory device with computer-readable program code stored thereon;
at least one communication device;
at least one processing device operatively coupled to the at least one memory device and the at least one communication device, wherein executing the computer-readable code is configured to cause the at least one processing device to:
receive an original image for analysis from a user device, wherein the original image comprises an image displayed on a graphical user interface of the user device;
encode the original image using multiple convolutional neural network layers;
store pooling indices for feature variance layers of the encoded image;
determine a classification on the feature variance layers of the encoded image; and
generate an output, wherein the output comprises a probabilistic distribution of one or more user interface objects within the original image.

2. The system of claim 1, wherein the system is further configured to apply a softmax activation function to determine the probabilistic distribution of one or more user interface objects within the original image.

3. The system of claim 1, wherein the feature variance layers of the encoded image are combined into a flattened layer prior to determining the classification.

4. The system of claim 1, wherein the one or more user interface objects comprise one or more of a text box, link, button, or check box within the original image.

5. The system of claim 1, further configured to reference a user interface object repository to determine one or more scripts corresponding the one or more user interface objects within the original image.

6. The system of claim 5, wherein the user interface object repository further comprises a table of object properties, object descriptions, and object examples.

7. The system of claim 5, further configured to identify one or more failures within a current deployment of the user interface; and
automate a solution to the one or more failures using data from the object repository.

8. A computer program product for automated user interface development with at least one non-transitory computer-readable medium having computer-readable program code portions embodied therein, the computer-readable program code portions comprising:
receive an original image for analysis from a user device, wherein the original image comprises an image displayed on a graphical user interface of the user device;
encode the original image using multiple convolutional neural network layers;
store pooling indices for feature variance layers of the encoded image;
determine a classification on the feature variance layers of the encoded image; and
generate an output, wherein the output comprises a probabilistic distribution of one or more user interface objects within the original image.

9. The computer program product of claim 8, wherein the system is further configured to apply a softmax activation function to determine the probabilistic distribution of one or more user interface objects within the original image.

10. The computer program product of claim 8 wherein the feature variance layers of the encoded image are combined into a flattened layer prior to determining the classification.

11. The computer program product of claim 8, wherein the one or more user interface objects comprise one or more of a text box, link, button, or check box within the original image.

12. The computer program product of claim 8, further configured to reference a user interface object repository to determine one or more scripts corresponding the one or more user interface objects within the original image.

13. The computer program product of claim 12, wherein the user interface object repository further comprises a table of object properties, object descriptions, and object examples.

14. The computer program product of claim 12, further configured to identify one or more failures within a current deployment of the user interface; and
automate a solution to the one or more failures using data from the object repository.

15. A computer-implemented method for in automated user interface development, the method comprising:
receiving an original image for analysis from a user device, wherein the original image comprises an image displayed on a graphical user interface of the user device;
encoding the original image using multiple convolutional neural network layers;
store pooling indices for feature variance layers of the encoded image;
determining a classification on the feature variance layers of the encoded image; and
generating an output, wherein the output comprises a probabilistic distribution of one or more user interface objects within the original image.

16. The computer-implemented method of claim 15, the method further comprising applying a softmax activation function to determine the probabilistic distribution of one or more user interface objects within the original image.

17. The computer-implemented method of claim 15, wherein the feature variance layers of the encoded image are combined into a flattened layer prior to determining the classification.

18. The computer-implemented method of claim 15, wherein the one or more user interface objects comprise one or more of a text box, link, button, or check box within the original image.

19. The computer-implemented method of claim 15, further configured to reference a user interface object repository to determine one or more scripts corresponding the one or more user interface objects within the original image.

20. The computer-implemented method of claim 19, wherein the user interface object repository further comprises a table of object properties, object descriptions, and object examples.
